(19) United States
(12) Patent Application Publication
(10) Pub. No.: US 2022/0405086 A1
(43) Pub. Date: Dec. 22, 2022

(54) SERVICE SYSTEM FOR UPDATING CONTROL PROGRAM, SERVER DEVICE, AND METHOD FOR UPDATING CONTROL PROGRAM IN SERVER DEVICE

(71) Applicant: Mitsubishi Electric Corporation, Tokyo (JP)

(72) Inventor: Kunio OHARA, Tokyo (JP)

(21) Appl. No.: 17/777,391

(22) PCT Filed: Jan. 22, 2020
(86) PCT No.: PCT/JP2020/002131

§ 371 Date: May 17, 2022

(51) Int. Cl. G06F 8/65; G06F 8/71

(52) U.S. Cl. CPC G06F 8/65; G06F 8/71

(57) ABSTRACT

A server device includes a learning circuitry configured to determine constraint information that is used when a control program for taking measures against a failure of a system that includes devices is selected, on the basis of first system configuration information that includes version information of a current control program of each of the devices included in the system and device identification information for identifying each of the devices, and failure information of the system, and an update control program output circuitry configured to output a control program for controlling a device whose current control program is to be updated among the devices included in the system, on the basis of the constraint information, which is used when a control program for taking measures against a failure of the system is selected, and, which is determined by the learning circuitry.

### TECHNICAL FIELD

The present disclosure relates to a service system for updating control programs of devices included in a system, a server device in such a service system, and a method for updating the control programs in the server device.

### BACKGROUND ART

There has been known a service system that updates control programs of devices included in an air-conditioning system connected to a server device via a network. In such a service system, when a control program is uploaded, the server device transmits a control program rewriting instruction to a device management apparatus that manages the air-conditioning system.

The device management apparatus transmits location information of the air-conditioning system that is obtained through radio waves transmitted from global positioning system (GPS) satellites, and the serial number of an air-conditioning apparatus to the server device.

On the basis of the location information and the serial number, the server device outputs control programs of the latest version for the devices included in the air-conditioning system. The device management apparatus rewrites the control program of each device to be updated, among the devices included in the air-conditioning system, with the control program of the latest version output from the server device (see, for example, Patent Literature 1).

### CITATION LIST

### Patent Literature

Patent Literature 1: Japanese Unexamined Patent Application Publication No. 2002-317995

### SUMMARY OF INVENTION

### Technical Problem

However, when the service system rewrites the control program of one of the devices included in the air-conditioning system with the control program of the latest version, the following problem cases, for example, are conceivable: a case where inconsistency of version configuration arises among the devices included in the air-conditioning system, thereby causing an operational failure in the air-conditioning system, and a case where a function introduced in the control program of the latest version has a problem and thus updating of the control program of the device of the air-conditioning system with the control program of the latest version is inappropriate.

In such cases, matching of the version information configurations among the devices included in the air-conditioning system or downgrading of the version information of the control program is required.

The present disclosure has been made to solve the above problems, and an object of the present disclosure is to provide a service system capable of updating devices included in the system with control programs of appropriate versions, a server device in such a service system, and a method for updating control programs in the server device.

### Solution to Problem

A server device according to an embodiment of the present disclosure includes a learning circuitry configured to determine constraint information that is used when a control program for taking measures against a failure of a system that includes devices is selected, on the basis of first system configuration information that includes version information of a current control program of each of the devices included in the system and device identification information for identifying each of the devices, and failure information of the system, and an update control program output circuitry configured to output a control program for controlling a device whose current control program is to be updated among the devices included in the system, on the basis of the constraint information, which is used when a control program for taking measures against a failure of the system is selected, and, which is determined by the learning circuitry.

### Advantageous Effects of Invention

According to an embodiment of the present disclosure, the learning circuitry of the server device is configured to determine constraint information that is used when a control program for taking measures against failure of the system is selected, on the basis of the failure information. In addition, on the basis of the constraint information, the update control program output circuitry is configured to output a control program for controlling a device whose current control program is to be updated. As a result, the device management apparatus of the system is configured to update the control program of the device to be updated with the control program output from the update control program output circuitry.

### BRIEF DESCRIPTION OF DRAWINGS

FIG. 1 is a diagram illustrating a service system of an air-conditioning system according to Embodiment 1.

FIG. 2 is a functional block diagram illustrating a function of a learning circuitry of a server device according to Embodiment 1.

FIG. 3 is a functional block diagram illustrating a function of a program selection circuitry of the server device according to Embodiment 1.

FIG. 4 is a functional block diagram illustrating a program update circuitry of the server device in the service system according to Embodiment 1.

FIG. 5 is a flowchart illustrating an operation of the service system according to Embodiment 1.

FIG. 6 is a flowchart illustrating an operation of the service system according to Embodiment 1.

FIG. 7 is a diagram illustrating the service system of the air-conditioning system according to Modification 4 of Embodiment 1.

FIG. 8 is a functional block diagram illustrating a function of a learning circuitry of the server device according to Embodiment 2.

FIG. 9 is a functional block diagram illustrating a function of the learning circuitry of the server device in the service system according to Modification 1 of Embodiment 2.

FIG. 10 is a functional block diagram illustrating a function of the learning circuitry of the server device according to Modification 2 of Embodiment 2.

FIG. 11 is a diagram illustrating a management company server that manages multiple properties according to Modification 2 of Embodiment 2.

FIG. 12 is a functional block diagram illustrating a function of the learning circuitry of the server device according to Modification 3 of Embodiment 2.

### DESCRIPTION OF EMBODIMENTS

Service systems of an air-conditioning system according to embodiments will be described below with reference to the drawings. Note that, the same component is denoted by the same reference sign in the drawings, and its description is not repeated unless necessary.

### Embodiment 1

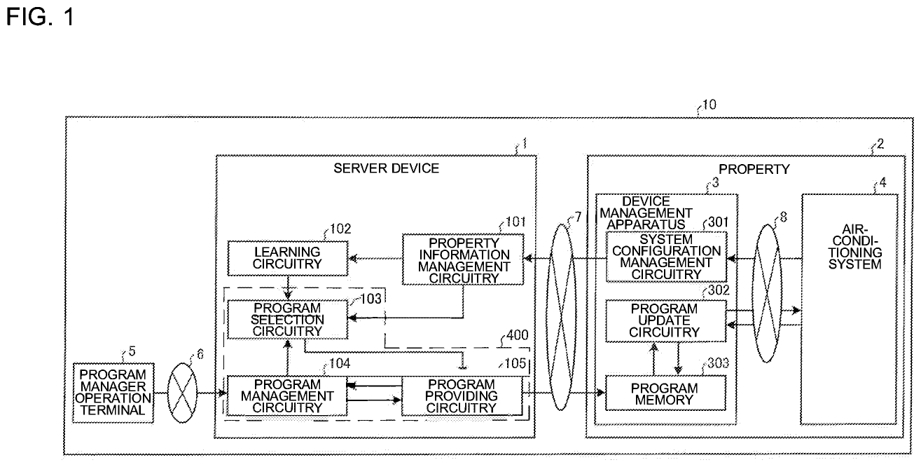

FIG. 1 is a diagram illustrating a service system 10 of an air-conditioning system 4 according to Embodiment 1.

As shown in FIG. 1, the service system 10 includes a program manager operation terminal 5, a server device 1, and a device management apparatus 3 and an air-conditioning system 4 of a property 2 that is a target of service. The program manager operation terminal 5 is connected to the server device 1 via a first network 6. The server device 1 is connected to the device management apparatus 3 of the property 2 via a second network 7. The device management apparatus 3 of the property 2 is connected to the air-conditioning system 4 via a third network 8.

The first network 6, the second network 7, and the third network 8 may be each a wired network or a wireless network. In addition, the first network 6, the second network 7, and the third network 8 may be the same network or different networks. The first network 6, the second network 7, and the third network 8 may be each a wired local area network (LAN) or a wireless LAN. Furthermore, the first network 6, the second network 7, and the third network 8 may include a public line network or the Internet.

The program manager operation terminal 5 is a terminal for a manager who manages control programs of devices included in the air-conditioning system 4. The air-conditioning system 4 includes a refrigerant circuit in which refrigerant flows through a compressor, a flow switching device, a condenser, an expansion valve, and an evaporator. Control programs are, for example, programs that control devices, such as the compressor, the flow switching device, the condenser, the expansion valve, and the evaporator, included in the refrigerant circuit of the air-conditioning system 4.

### Server Device 1

The server device 1 includes a property information management circuitry 101, a learning circuitry 102, a program selection circuitry 103, a program management circuitry 104, and a program providing circuitry 105.

The property information management circuitry 101 is configured to periodically receive current first system configuration information and failure information of each of the devices included in the air-conditioning system 4 from the device management apparatus 3 belonging to the property 2. The “first system configuration information” includes version information of the current control program of each of the devices included in the air-conditioning system 4, and device identification information that identifies each of the devices. Examples of the device identification information include a model name, a serial number, and an address of each of the devices included in the air-conditioning system 4. The “failure information” indicates abnormalities of the air-conditioning system 4 and includes a history of abnormality occurrences and data on operation before abnormality occurrence. In addition, the property information management circuitry 101 is configured to output the first system configuration information and the failure information received from the device management apparatus 3 to the learning circuitry 102. Furthermore, the property information management circuitry 101 is configured to output the first system configuration information received from the device management apparatus 3 to the program selection circuitry 103.

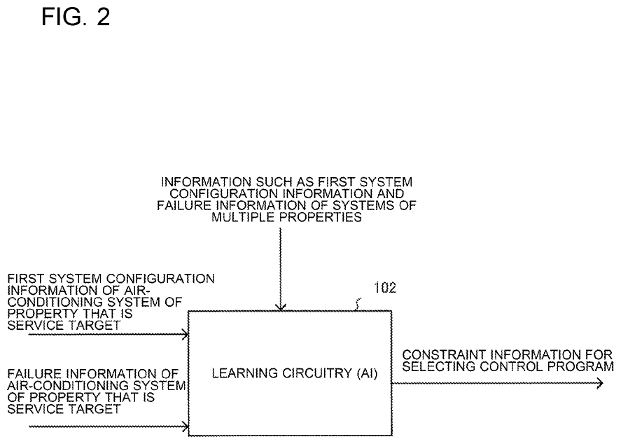

The learning circuitry 102 has an artificial intelligence (AI) function. FIG. 2 is a functional block diagram illustrating a function of the learning circuitry 102 of the server device 1 according to Embodiment 1. From each property 2, the first system configuration information and the failure information of the corresponding system are input from the corresponding device management apparatus 3 to the learning circuitry 102 via the property information management circuitry 101. The learning circuitry 102 is configured to analyze the first system configuration information and the failure information of the systems of multiple properties 2 by use of the AI function. The learning circuitry 102 is configured to learn the first system configuration information and the failure information of the systems of the multiple properties 2 to create a learning model. For the first system configuration information and the failure information having been input to the learning circuitry 102, of the air-conditioning system 4 of the property 2 that is a target of service, the learning circuitry 102 is configured to determine constraint information that is used when a control program is selected by use of the learning model, and output the determined constraint information to the program selection circuitry 103. Examples of the “constraint information that is used when a control program is selected” include information that identifies version information of a control program that is effective as a measure against a failure, and information on version information configuration pattern that should be avoided. The version information configuration pattern is, for example, a pattern of version information for the control program of each of the devices included in the air-conditioning system 4.

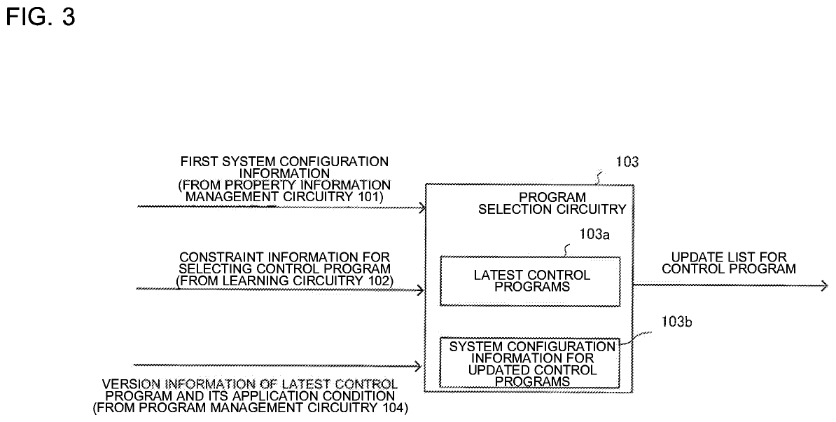

FIG. 3 is a functional block diagram illustrating a function of the program selection circuitry 103 of the server device 1 according to Embodiment 1.

The program selection circuitry 103 is configured to create second system configuration information on updated control programs. The second system configuration information is created on the basis of the first system configuration information input from the property information management circuitry 101, the constraint information, which is used when a control program is selected, and, which is input from the learning circuitry 102, and latest version information of the latest control program and its application condition input from the program management circuitry 104. The application condition for the latest control program is, for example, a condition range that a program designer of the latest control program specifies to ensure operation of the program, such as that the version information of an indoor unit and that of an outdoor unit should be the same, and that an outdoor unit with a branch controller should have the latest control program. The application condition for the latest control program may be input into the learning circuitry 102. This improves the accuracy of the constraint information, which is used when a control program is selected. The “second system configuration information” includes version information of the updated control program of each of the devices included in the air-conditioning system 4 and device identification information that identifies each of the devices. Examples of the device identification information include a model name, a serial number, and an address of each of the devices included in the air-conditioning system 4. Note that the second system configuration information does not necessarily include the device identification information, which identifies a device to be updated. The program selection circuitry 103 is configured to determine whether or not the version information of the current control program included in the first system configuration information is the same as the version information of the updated control program included in the created second system configuration information. When the program selection circuitry 103 determines that the version information of the current control program is the same as the version information of the updated control program, the program selection circuitry 103 outputs, to the program providing circuitry 105, an instruction indicating that no update of the control program is required. When the program selection circuitry 103 determines that the version information of the current control program is not the same as the version information of the updated control program, the program selection circuitry 103 outputs, to the program providing circuitry 105, a control program update instruction indicating that update of the control program is required. Furthermore, the program selection circuitry 103 is configured to create an update list for control program. The update list for control program indicates a device to be update and the version information of its control program included in the first system configuration information, the device having the version information different from the version information of the updated control program included in the created second system configuration information. The program selection circuitry 103 outputs the created update list to the program providing circuitry 105.

The “update list” may include a set of a device to be updated and an updated control program to be introduced in the device to be updated. An updated control program of the update list may be an output of the updated control program itself. In addition, the content of the update list may be a content that specifies an updated control program, such as a version information name and a program identification information.

The device identification information for specifying a device to be updated may include the following information:
Information specifying a particular model, such as information that indicates devices of the same model existing in the air-conditioning system 4 of the property 2,
Information specifying an individual unit existing in the air-conditioning system 4 of the property 2 by use of Internet Protocol (IP) or other protocol, and
Information specifying an individual unit of a particular model by use of the information thus specifying the particular model and the information thus specifying the individual unit.

The program management circuitry 104 is configured to receive, and store a control program of the latest version information and its application condition from the program manager operation terminal 5 via the first network 6. In addition, the program management circuitry 104 is configured to output the latest version information of the control program and its application condition to the program selection circuitry 103. Furthermore, the program management circuitry 104 is configured to output a control program of the version information included in the update list for control program input from the program providing circuitry 105, to the program providing circuitry 105.

The program providing circuitry 105 is configured to determine whether or not the version information of a control program included in the update list for control program is the same as the version information of a control program input from the program management circuitry 104. When the program providing circuitry 105 determines that the version information pieces are the same, the program providing circuitry 105 is configured to output the control program and the update list, via the second network 7, to the device management apparatus 3 belonging to the property 2 that is a target of service. The control program is input from the program management circuitry 104. The update list is input from the program selection circuitry 103.

In Embodiment 1 and Embodiment 2, which will be described later, the program selection circuitry 103, the program management circuitry 104, and the program providing circuitry 105 are also collectively referred to as an update control program output circuitry 400.

### Device Management Apparatus 3

As shown in FIG. 1, the device management apparatus 3 includes a system configuration management circuitry 301, a program update circuitry 302, and a program memory 303.

The system configuration management circuitry 301 is configured to periodically collect first system configuration information and failure information from each of the devices included in the air-conditioning system 4 via the third network 8. The system configuration management circuitry 301 outputs the collected first system configuration information and failure information to the server device 1 via the second network 7.

The program memory 303 is configured to store control programs and the update list for control program that are input from the program providing circuitry 105 of the server device 1 via the second network 7. In addition, the program memory 303 outputs the stored update list for control program to the program update circuitry 302. Furthermore, the program memory 303 outputs the control program for controlling a device to be updated to the program update circuitry 302 at an update timing instructed by the program update circuitry 302.

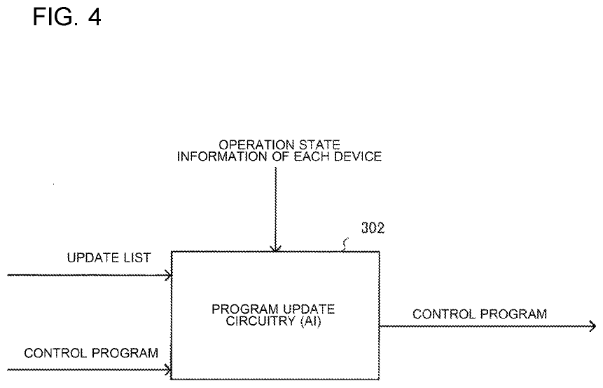

The program update circuitry 302 is configured to collect an operation state of each of the devices included in the air-conditioning system 4 via the third network 8. At a timing at which a device to be updated is stopped, the program update circuitry 302 instructs the program memory 303 to output a control program for controlling the device to be updated on the basis of the update list to acquire the control program of the device to be updated. The program update circuitry 302 updates the current control program of the device to be updated with the control program acquired from the program memory 303. FIG. 4 is a functional block diagram illustrating the program update circuitry 302 of the device management apparatus 3 in the service system 10 according to Embodiment 1. The program update circuitry 302 has an AI function. The program update circuitry 302 collects an operation state of each of the devices included in the air-conditioning system 4 and analyzes the collected operation states to create an operation schedule. The program update circuitry 302 determines update timings for control programs on the basis of the created operation schedule. The program update circuitry 302 determines whether or not a device whose control program is to be updated is in a stop state. When the program update circuitry 302 confirms that the device to be updated is in a stop state, the program update circuitry 302 writes the control program for controlling the device to be updated input from the program memory 303 into the device to be updated on the basis of the update list. As a result, the control program of the device to be updated in the air-conditioning system 4 is updated.

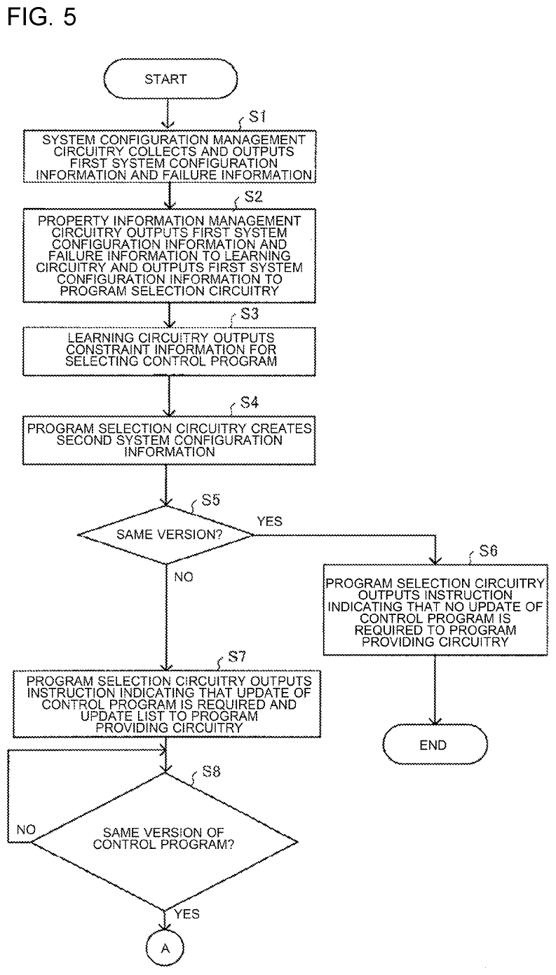

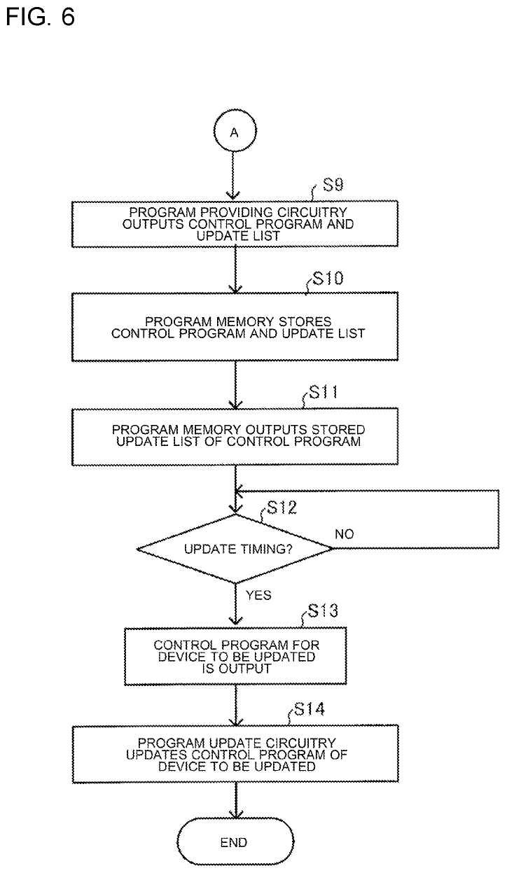

Next, an operation of the service system 10 of the air-conditioning system 4 according to Embodiment 1 will be described. FIGS. 5 and 6 show a flowchart illustrating an operation of the service system 10 according to Embodiment 1.

First, the system configuration management circuitry 301 periodically collects, via the third network 8, first system configuration information and failure information from a control device that controls the devices included in the air-conditioning system 4. The system configuration management circuitry 301 outputs the collected first system configuration information and failure information to the server device 1 via the second network 7 (step S1).

The property information management circuitry 101 of the server device 1 receives the current first system configuration information and failure information of each of the devices included in the air-conditioning system 4 from the device management apparatus 3 belonging to the property 2. The property information management circuitry 101 outputs the received first system configuration information and failure information to the learning circuitry 102 and outputs the received first system configuration information to the program selection circuitry 103 (step S2).

The learning circuitry 102 analyzes the first system configuration information and failure information, which have been input to the learning circuitry 102 from the device management apparatuses 3 of multiple properties, by use of the AI function. As a result of the analysis by the AI function for the first system configuration information and the failure information having been input to the learning circuitry 102, of the air-conditioning system 4 that is a target of service, the learning circuitry 102 outputs constraint information that is used when a control program is selected, to the program selection circuitry 103 (step S3). Examples of the constraint information, which is used when a control program is selected, include information that identifies the version information of a control program that is effective as a measure against a failure, and information on version information configuration pattern that should be avoided.

The program selection circuitry 103 creates second configuration system information for the updated control programs by use of the first system configuration information as a base, on the basis of the first system configuration information input from the property information management circuitry 101, the constraint information, which is used when a control program is selected, and, which is input from the learning circuitry 102, and latest version information and application conditions for the control programs input from the program management circuitry 104 (step S4).

The program selection circuitry 103 determines whether or not the version information of a current control program included in the first system configuration information is the same as the version information of the updated control program included in the second system configuration information created in step S4 (step S5).

When the program selection circuitry 103 determines that both version information pieces are the same in step S5 (YES in step S5), the program selection circuitry 103 outputs an instruction indicating that no update of the control program is required to the program providing circuitry 105 (step S6). It is recognized that no update of the control program is necessary, and the processing is thus ended.

Meanwhile, when the program selection circuitry 103 determines that both version information pieces are not the same in step S5 (NO in step S5), the program selection circuitry 103 outputs an instruction indicating that update of the control program is required and an update list for control program to the program providing circuitry 105 (step S7).

The program providing circuitry 105 determines whether or not the version information of the control program included in the update list for control program and the version information of the control program input from the program management circuitry 104 are the same (step S8).

In step S8, when both version information pieces of the control programs are the same (YES in step S8), the program providing circuitry 105 outputs the control program input from the program management circuitry 104 and the update list for control program input from the program selection circuitry 103 to the program memory 303 of the device management apparatus 3 belonging to the property 2, via the second network 7 (step S9). Meanwhile, in step S8, when both version information pieces of the control programs are not the same (NO in step S8), the determination in step S8 is continued.

The program memory 303 stores the control program and the update list for control program input from the server device 1 via the second network 7 (step S10). Next, the program memory 303 outputs the stored update list for control program to the program update circuitry 302 (step S11).

Next, the program memory 303 determines whether or not it is an update timing instructed by the program update circuitry 302 (step S12). This determination of an update timing is made for each of the devices included in the air-conditioning system 4.

In step S12, when the program memory 303 determines that it is not an update timing instructed by the program update circuitry 302 (NO in step S12), the determination is continued. Meanwhile, when the program memory 303 determines that it is an update timing instructed by the program update circuitry 302 (YES in step S12), the program memory 303 outputs the control program for controlling a device to be updated to the program update circuitry 302 (step S13).

The program update circuitry 302 updates the current control program of the device to be updated with the control program output from the program memory 303 on the basis of the update list (step S14), and the processing is ended.

According to Embodiment 1, by analyzing system configuration information and failure information of multiple properties, the learning circuitry 102 outputs constraint information that is used when a control program is selected, such as information that specifies version information of a control program that is effective as a measure against a failure, and information on version information configuration pattern that should be avoided. By use of such constraint information that is used when a control program is selected, the program selection circuitry 103 is configured to select an appropriate control program in consideration of consistency of version information among the devices included in the air-conditioning system 4.

In addition, because only devices whose control programs need to be updated are listed in the update list for control program created by the program selection circuitry 103, a data communication capacity between the server device 1 and the device management apparatus 3 of each property is reduced.

Furthermore, by use of the AI function, the program update circuitry 302 creates an operation schedule from accumulated data on operation states of the air-conditioning system 4. As a result, the program update circuitry 302 is configured to update the control program for each of the devices included in the air-conditioning system 4 at a timing corresponding to the usage condition.

### Modification 1

In the service system 10 of Embodiment 1, the device management apparatus 3 may be included in a main device among the devices included in the air-conditioning system 4.

### Modification 2

In the service system 10 of Embodiment 1, each of the devices included in the air-conditioning system 4 may be provided with the functions of the program update circuitry 302 and the program memory 303, and only a main device among the devices may be provided with the function of the system configuration management circuitry 301, in addition to the functions of the program update circuitry 302 and the program memory 303. The program update circuitry 302 in the service system 10 of Modification 2 of Embodiment 1 has only to manage an operation schedule for operation states of the own device. The service system 10 of Modification 2 of Embodiment 1 is configured to obtain the effect similar to the service system 10 of Embodiment 1.

### Modification 3

In the service system 10 of Embodiment 1, the server device 1 may include the functions of the device management apparatus 3. In a case of Modification 3, the property information management circuitry 101 has the function of the system configuration management circuitry 301. In addition, the program providing circuitry 105 has the function of the program update circuitry 302. According to Modification 3, in the property 2, it is not required to provide a device management apparatus separately from the air-conditioning system. The service system 10 of Modification 3 of Embodiment 1 is configured to obtain the effect similar to the service system 10 of Embodiment 1.

### Modification 4

In the service system 10 of Embodiment 1, the program manager operation terminal 5 receives first system configuration information and failure information from the property information management circuitry 101. The program manager operation terminal 5 may input constraint information for program selection to the learning circuitry 102 as teacher data for AI.

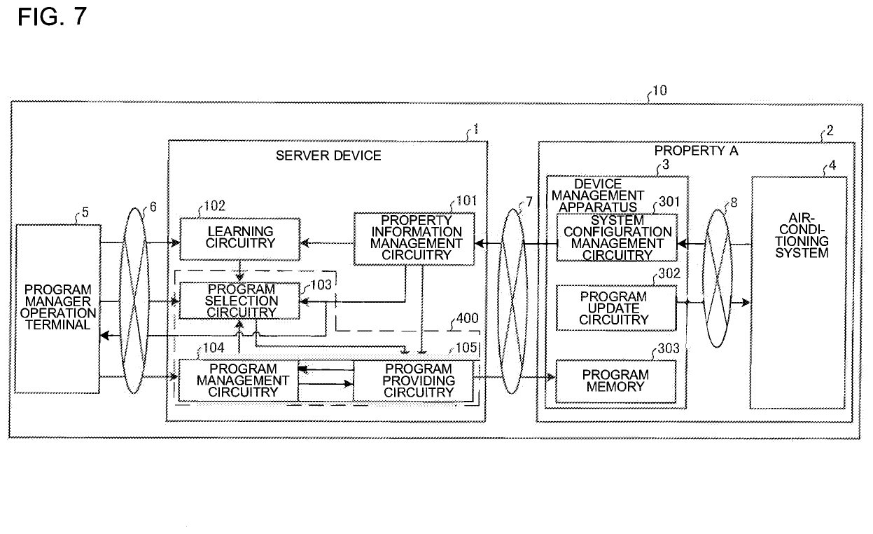

In addition, the program manager operation terminal 5 may directly specify the control program of the latest version to be supplied to the program selection circuitry 103. FIG. 7 is a diagram illustrating the service system 10 of the air-conditioning system 4 according to Modification 4 of Embodiment 1. As shown in FIG. 7, the program manager operation terminal 5 is capable of directly communicating with the learning circuitry 102, the program selection circuitry 103, and the program management circuitry 104 of the server device 1 via the first network 6.

The service system 10 of Modification 4 of Embodiment 1 is configured to obtain the effect similar to the service system 10 of Embodiment 1.

Furthermore, by inputting teacher data to the AI function provided in the learning circuitry 102 by the program manager operation terminal 5, each AI function is caused to provide a learning result intended by a program manager.

### Embodiment 2

The service system 10 according to Embodiment 2 has such a configuration that the learning circuitry 102 of the service system 10 according to Embodiment 1 further includes a function that notifies the program manager operation terminal 5, or a similar device, of a cause of failure.

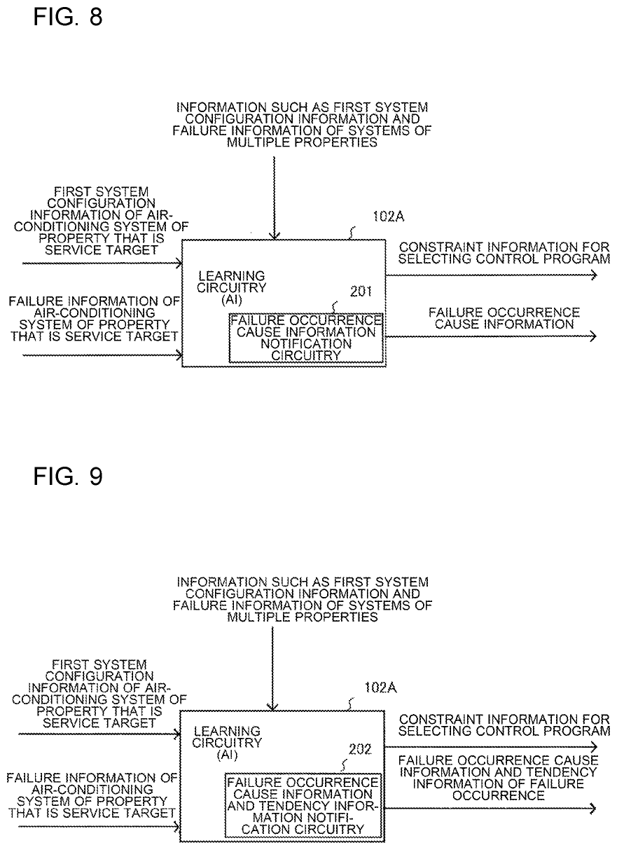

FIG. 8 is a functional block diagram illustrating a function of a learning circuitry 102A of the server device 1 according to Embodiment 2.

As shown in FIG. 8, the learning circuitry 102A of the server device 1 according to Embodiment 2 has a failure occurrence cause information notification circuitry 201.

The failure occurrence cause information notification circuitry 201 is configured to analyze a failure of the air-conditioning system 4 of the property 2 on the basis of, for example, the first system configuration information and failure information of multiple properties accumulated in the learning circuitry 102A and the first system configuration information and failure information input from the device management apparatus 3 of the property 2. The failure occurrence cause information notification circuitry 201 outputs, as an analysis result, failure occurrence cause information indicating a cause of the failure occurrence to the program manager operation terminal 5. Note that, the failure occurrence cause information may be output to a terminal (not shown) of a designer of a control program.

The “failure occurrence cause information” is information based on the information of failures that have already occurred. For example, the failure occurrence cause information notification circuitry 201 analyzes failure occurrence causes from the first system configuration information of a few dozen properties at which failures occurred. Examples of the failure occurrence causes include: (A) a case where the system is extended to a device that the current control program does not support, (B) a case where a program to which a function that interlocks an outdoor unit with a branch controller is added is uploaded only to the outdoor unit but the control program of the branch controller is not updated, and (C) a case where the control program has a problem.

Therefore, by use of the service system 10 of Embodiment 2, a control program manager utilizes the failure occurrence cause information received from the server device 1 in designing a failure countermeasure program.

Note that, when the first system configuration information has more than one occurrences of a particular failure, the learning circuitry 102A may output the probability of occurrence of the particular failure, and may notify in advance the people involved (management companies and customers) of a possible failure occurrence, its countermeasure, and a release schedule for the corresponding correction program at the present time.

### Modification 1

A failure occurrence cause information and tendency information notification circuitry 202 of the learning circuitry 102A in the service system 10 of Modification 1 is configured to notify tendency information of failure occurrence, in addition to the failure occurrence cause information.

FIG. 9 is a functional block diagram illustrating a function of the learning circuitry 102A of the server device 1 in the service system 10 according to Modification 1 of Embodiment 2.

As shown in FIG. 9, the learning circuitry 102A of the server device 1 according to Modification 1 of Embodiment 2 includes the failure occurrence cause information and tendency information notification circuitry 202.

The failure occurrence cause information and tendency information notification circuitry 202 is configured to analyze failures of the air-conditioning system 4 of the property 2 on the basis of, for example, the first system configuration information and failure information of multiple properties accumulated in the learning circuitry 102 and the first system configuration information and failure information input from the device management apparatus 3 of the property 2. The failure cause information and tendency information notification circuitry 202 outputs, as an analysis result, failure occurrence cause information and tendency information indicating tendencies of failure occurrence to the program manager operation terminal 5. Note that, the failure occurrence cause information and tendency information may be output to a terminal (not shown) of a designer of a control program.

The “failure occurrence cause information” is information based on the information of failures that have already occurred. The “tendency information of failure occurrence” output from the failure cause information and tendency information notification circuitry 202 of Modification 1 is information indicating a fundamental occurrence tendency of a failure estimated from the failure occurrence cause information and includes the information included in the first system configuration information of the air-conditioning system 4 having a tendency of failure occurrence. The tendency of failure occurrence is a tendency including, for example, the possibility of failure occurrence in a combination of devices in which a failure has not been reported to occur yet.

Therefore, by use of the service system 10 of Modification 1 of Embodiment 2, a program manager utilizes the failure occurrence cause information and the tendency of failure occurrence received from the server device 1 in designing a more general-purpose failure countermeasure program.

### Modification 2

The learning circuitry 102 of the service system 10 of Modification 2 has such a configuration that the learning circuitry 102 of Embodiment 2 further includes a proposal information notification circuitry 203.

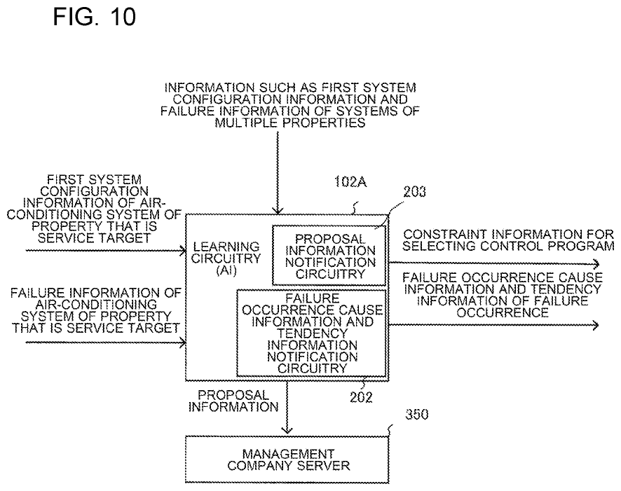

FIG. 10 is a functional block diagram illustrating a function of the learning circuitry 102A of the server device 1 according to Modification 2 of Embodiment 2.

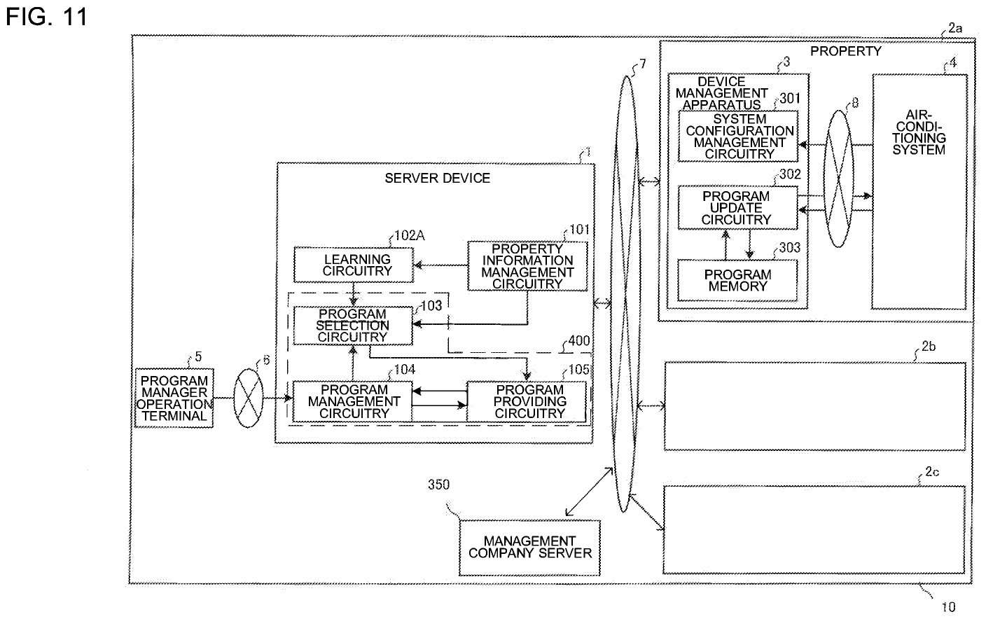

The proposal information notification circuitry 203 is configured to output proposal information indicating a proposal for failure handling to a management company server 350 of a management company that manages properties 2. The management company server 350 may be a server that manages multiple properties 2 or a server that manages one property 2. FIG. 11 is a diagram illustrating the management company server 350 that manages multiple properties 2a to 2c according to Modification 2 of Embodiment 2. As shown in FIG. 11, the server device 1 manages the multiple properties 2a to 2c. The configuration of each of the properties 2b and 2c is the same as that of the property 2a. Note that description of the configuration will be omitted. The management company server 350 is connected to the second network 7 and is a server of a management company that manages the properties 2a to 2c.

More specifically, the proposal information notification circuitry 203 is configured to determine whether or not first system configuration information that includes failure occurrence tendency information indicating a tendency of failure occurrence acquired from the failure occurrence cause information and tendency information notification circuitry 202 is present among the first system configuration information pieces of the air-conditioning systems 4 of the properties 2a to 2c.

When the proposal information notification circuitry 203 determines that first system configuration information that includes the failure occurrence tendency information is present, the proposal information notification circuitry 203 outputs proposal information indicating a proposal for failure handling to the management company server 350 that manages the property 2 having the air-conditioning system 4 specified by the first system configuration information determined to be present. When the proposal information notification circuitry 203 determines that no first system configuration information that includes failure occurrence tendency information is present, the proposal information notification circuitry 203 does not output proposal information.

Proposals indicated by the proposal information include the following proposals, for example.
A proposal for upgrading or downgrading the program of each of the devices included in the air-conditioning system 4.

For example, in the case (B) described above, that is, in a case where a program to which a function that interlocks an outdoor unit with a branch controller is added is uploaded only to the outdoor unit but the control program of the branch controller is not updated, the proposal information notification circuitry 203 outputs the following proposal information.

The proposal information notification circuitry 203 outputs proposal information indicating that the program of the branch controller be upgraded when there is any correction program. When there is no correction program yet, the proposal information notification circuitry 203 outputs proposal information indicating that the program of the outdoor unit be downgraded.
A proposal for changing the setting of each of the devices without changing the program.

For example, in the case (A) described above, that is, in a case where the system is extended to a device that the current control program does not support, the proposal information notification circuitry 203 outputs proposal information indicating that connection to the device that the current control program does not support be released temporarily.

Next, timing of notifying the management company server 350 of proposal information by the proposal information notification circuitry 203 will be described.

The proposal information notification circuitry 203 is configured to periodically receive first system configuration information and failure information from each property 2. When the proposal information notification circuitry 203 receives first system configuration information and failure information from one of the target properties, the proposal information notification circuitry 203 determines whether or not the first system configuration information of the target property includes failure occurrence tendency information. Then, when the proposal information notification circuitry 203 determines that the first system configuration information of the target property includes failure occurrence tendency information, the proposal information notification circuitry 203 transmits proposal information to the management company server 350 that manages the air-conditioning system 4 specified by the first system configuration information of the target property.

By use of the service system 10 of Modification 2 of Embodiment 2, by referring to a proposal indicated by proposal information, which is transmitted to the management company server 350 for failure handling, the manager or the designer of a program utilizes the proposal in designing a failure countermeasure program, and compares the proposal with a handling method specified by the manager or the designer to find a more reliable handling method.

### Modification 3

The learning circuitry 102 of the service system 10 of Modification 3 has such a configuration that the learning circuitry 102A of Embodiment 2 further includes a predictive information notification circuitry 204.

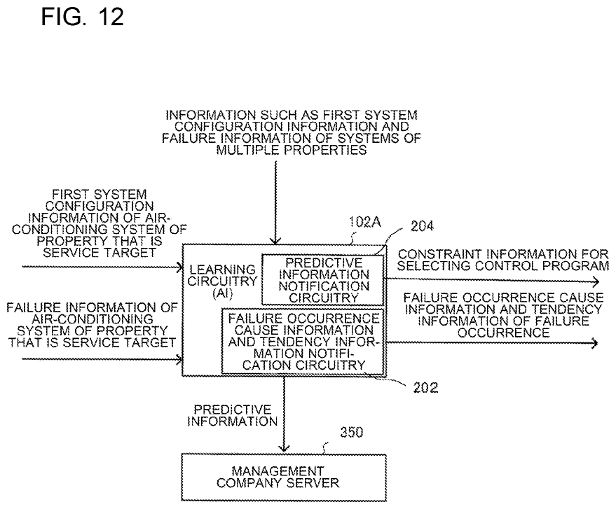

FIG. 12 is a functional block diagram illustrating a function of the learning circuitry 102A of the server device 1 according to Modification 3 of Embodiment 2.

The predictive information notification circuitry 204 is configured to output predictive information that includes a failure prediction and its recommended countermeasure to the management company server 350 that manages the multiple properties 2a to 2c.

More specifically, the predictive information notification circuitry 204 is configured to determine whether or not first system configuration information is present that includes failure occurrence tendency information indicating a tendency of failure occurrence acquired from the failure occurrence cause information and tendency information notification circuitry 202, and that indicates that the probability of failure occurrence is a certain probability value or higher and abnormal stopping is expected in the corresponding air-conditioning system 4, among the first system configuration information pieces of the air-conditioning systems 4 of the properties 2a to 2c.

When the predictive information notification circuitry 204 determines that such first system configuration information is present, the predictive information notification circuitry 204 outputs predictive information that includes a failure prediction and its recommended countermeasure to the management company server 350 that manages the property 2 having the air-conditioning system 4 specified by the first system configuration information determined to be present. When the predictive information notification circuitry 204 determines that no such first system configuration information is present, the predictive information notification circuitry 204 does not output predictive information. Note that the predictive information notification circuitry 204 may transmit predictive information to the program manager operation terminal 5. The management company server 350 and the program manager operation terminal 5 are capable of selecting whether or not to receive predictive information.

By use of the service system 10 of Modification 3 of Embodiment 2, by referring to the failure prediction and its recommended countermeasure indicated by the predictive information transmitted to the management company server 350, the manager and the designer of a program responds quickly to a failure with high urgency whose probability of failure occurrence is a certain probability value or higher.

Although Embodiments 1 and 2 describe the service systems for the air-conditioning system 4, the service system of Embodiment 1 or 2 may be applied also to other systems having multiple component devices.

The embodiments are presented as examples and the scope of the embodiments is not intended to be limited. The embodiments may be in other various forms, and various omissions, replacements, and modifications may be made to the embodiments without departing from the gist of the embodiments. These embodiments and its modifications are included in the scope and gist of the embodiments.

### REFERENCE SIGNS LIST

1: server device, 2: property, 3: device management apparatus, 4: air-conditioning system, 5: program manager operation terminal, 6: first network, 7: second network, 8: third network, 10: service system, 101: property information management circuitry, 102, 102A: learning circuitry, 103: program selection circuitry, 104: program management circuitry, 105: program providing circuitry, 201: failure occurrence cause information notification circuitry, 202: failure occurrence cause information and tendency information notification circuitry, 203: proposal information notification circuitry, 204: predictive information notification circuitry, 301: system configuration management circuitry, 302: program update circuitry, 303: program memory, 350: management company server, 400: update control program output circuitry

1. A server device comprising:
a learning circuitry configured to determine constraint information that is used when a control program for taking measures against a failure of a system that includes devices is selected, on a basis of first system configuration information that includes version information of a current control program of each of the devices included in the system and device identification information for identifying each of the devices, and failure information of the system; and
an update control program output circuitry configured to output a control program for controlling a device whose current control program is to be updated among the devices included in the system, on a basis of the constraint information, which is used when a control program for taking measures against a failure of the system is selected, and, which is determined by the learning circuitry,
the update control program output circuitry including
a program selection circuitry configured to acquire second system configuration information that includes version information of an updated control program of each of the devices included in the system, on a basis of the first system configuration information and the constraint information, which is used when a control program is selected, and, which is determined by the learning circuitry, and configured to output information of a device to be updated whose version information in the first system configuration information does not match the version information of the updated control program included in the acquired second system configuration information, and identification information of the control program of the device to be updated,
a program providing circuitry configured to output the control program or the identification information of the control program output from the program selection circuitry, and
a program management circuitry configured to output, to the program providing circuitry, a control program of the device to be updated specified by the identification information of the control program output from the program providing circuitry,
the program providing circuitry being configured to output the control program output from the program management circuitry or the identification information of the control program when version information of the control program output from the program management circuitry matches the version information of the control program output from the program selection circuitry or the version information of the control program indicated by the identification information of the control program.

2. (canceled)

3. The server device of claim 1, wherein the program selection circuitry is further configured to acquire the second system configuration information on a basis of an application condition for a latest control program.

4. The server device of claim 1, wherein the program providing circuitry is configured to output the control program or the identification information of the control program output from the program selection circuitry when the program selection circuitry outputs a control program update instruction.

5. (canceled)

6. The server device of claim 1, wherein the learning circuitry is configured to determine a cause of the failure and configured to output failure cause information that indicates the determined cause of the failure.

7. The server device of claim 6, wherein the learning circuitry is further configured to output tendency information that indicates a tendency of occurrence of the failure.

8. The server device of claim 7, wherein the learning circuitry is configured to determine proposal information that indicates handling of the failure and further configured to output the determined proposal information.

9. The server device of claim 8, wherein the learning circuitry is further configured to output predictive information that indicates a prediction of the failure and a recommended countermeasure against the failure.

10. A service system comprising:
the server device of claim 1; and
a device management apparatus that has a system configuration management circuitry configured to periodically collect the first system configuration information and the failure information from each of the devices included in the system and configured to output the first system configuration information and the failure information to the server device.

11. The service system of claim 10, wherein the server device further includes a property information management circuitry configured to output the first system configuration information and the failure information output from the system configuration management circuitry to the learning circuitry and configured to output the first system configuration information output from the system configuration management circuitry to the program selection circuitry.

12. The service system of claim 10, wherein
the device management apparatus further includes
a program memory configured to store the control program or the identification information of the control program output from the program providing circuitry, and
a program update circuitry configured to collect an operation state of a device to be updated, among the devices included in the system, on a basis of the control program or the identification information of the control program output from the program providing circuitry, configured to determine whether or not the device to be updated is stopped on a basis of the collected operation state, and configured to update the control program of the device to be updated with the control program stored in the program memory when it is determined that the device to be updated is stopped.

13. A method for updating a control program in a server device, the server device comprising:
a learning circuitry configured to determine constraint information that is used when a control program for taking measures against a failure of a system that includes devices is selected, on a basis of first system configuration information that includes version information of a current control program of each of the devices included in the system and device identification information for identifying each of the devices, and failure information of the system, by use of a learning model obtained by learning the first system configuration information and the failure information of a plurality of the systems; and
an update control program output circuitry configured to output a control program for controlling a device whose current control program is to be updated among the devices included in the system, on a basis of the determined constraint information, which is used when a control program for taking measures against a failure of the system is selected,
the update control program output circuitry including a program selection circuitry, a program providing circuitry, and a program management circuitry,
the program selection circuitry being configured to acquire second system configuration information that includes version information of an updated control program of each of the devices included in the system, on a basis of the first system configuration information and the constraint information, which is used when a control program is selected, and, which is determined by the learning circuitry, and configured to output information of a device to be updated whose version information in the first system configuration information does not match the version information of the updated control program included in the acquired second system configuration information, and identification information of the control program of the device to be updated,
the program providing circuitry being configured to output the control program or the identification information of the control program output from the program selection circuitry,
the program management circuitry being configured to output, to the program providing circuitry, a control program of the device to be updated specified by the identification information of the control program output from the program providing circuitry,
the program providing circuitry being configured to output the control program output from the program management circuitry or the identification information of the control program when version information of the control program output from the program management circuitry matches the version information of the control program output from the program selection circuitry or the version information of the control program indicated by the identification information of the control program.
